(19) United States
(12) Patent Application Publication
(10) Pub. No.: US 2016/0331070 A1
(43) Pub. Date: Nov. 17, 2016

(54) Devices for Treating Targeted Physical and Mental Conditions

(71) Applicant: Marie L. Williams P.D.M., Aventura, FL (US)

(72) Inventor: Marie L. Williams P.D.M., Aventura, FL (US)

(73) Assignee: G&J Kerr Associates, LLC, Miami Beach, FL (US)

(21) Appl. No.: 14/714,268

(22) Filed: May 16, 2015

(51) Int. Cl. A43B 7/14; A61H 39/04; A43B 17/00; A41B 11/00

(52) U.S. Cl. CPC A43B 7/146; A43B 7/1465; A41B 11/00; A61H 39/04; A43B 17/00; A61H 2205/125

(57) ABSTRACT

The present disclosure relates to medical devices and methods of their use. More particularly, the disclosure relates to devices and methods that are used to treat a variety of physical and/or mental conditions. The disclosed devices and methods selectively apply pressure to the soles of the foot in chosen areas which are known to affect treatment so that one or more specific treatments can occur.

### FIELD OF DISCLOSURE

The present disclosure relates to medical devices and methods of their use. More particularly, the disclosure relates to devices and methods that are used to treat a variety of physical and/or mental conditions. The disclosed devices and methods selectively apply pressure to the soles of the foot in chosen areas which are known to affect treatment so that one or more specific treatments can occur.

### BACKGROUND OF THE DISCLOSURE

Reflexology, or acupressure, is an ancient technique involving the compression or finger massaging of the sole of the foot at strategic, targeted areas. These areas are known to have an intimate connection with various organs and muscles of the body. Not to be held to theory it is believed that pressure on very specific areas of the sole of the foot, the size of which can vary from a few square centimeters to hundreds of square centimeters, can stimulate blood flow to the specific organ or muscle as well as improve nerve response to the organ or muscle. The unifying theme is the idea that areas on the foot correspond to areas of the body, and that by manipulating these one can treat certain physical and/or mental conditions.

Devices have been put forth that integrate the foot reflexology and acupres sure theory generally by placing protuberances onto or into the insole of a shoe, such as a shoe insert, so that the wearer receives acupres sure at various points on the soles of his/her feet as he/she walks around. The currently available devices generally have a large, non-specific number of protuberances that applies acupressure onto a large portion of the sole of the foot, see, for example, U.S. Pat. No. 4,841,647 to Turucz. Again not to be held to theory, it is believed that applying pressure to too many areas of the foot at one time causes general dilution of therapeutic effect such that little to no benefit can be achieved. As such it is believed that acupres sure on one or more related reflexology points provides the beneficial desired therapeutic effect. The currently available devices are static devices in which the large numbers of protuberances are permanent and unchangeable.

Thus if a specific treatment is desired, there are no current devices that can be used for such specific treatment. Additionally, because of the static nature of the current devices, a device for a specific treatment, if it were available, could not be used for any other treatment, so that a new device would need to be obtained if a different treatment were desire. As can be seen, this procedure can be expensive and cumbersome to obtain a number of devices for a number of treatment.

One device that has been proposed to address the static nature of the currently available devices is a device into which pins can be selectively placed through holes which are predrilled into the basic device form. These pins have been described as being useful to relieve tension and stress, see U.S. Pat. No. 6,742,289 to Celmo. Pins protruding through the insole of a shoe have the obvious disadvantage of being extremely uncomfortable, bordering on painful, such that much of the therapeutic benefit is lost as the application of pins can only be tolerated for a short period of time, depending on the pain threshold of the wearer. Additionally, pins apply pressure to very small, pin-point areas of the sole of the foot for reflexology purposes, while generally the benefits of reflexology are obtained by putting pressure on larger areas of the foot, not solely on a tiny point.

Thus there is a need for reflexology devices which contain protuberances that can be applied for a specific treatment while allowing for alterations that can address different treatments as desired.

### SUMMARY OF THE EXEMPLARY EMBODIMENTS

It is an object of the current disclosure to overcome the deficiencies commonly associated with the devices currently available for reflexology treatment, as discussed above, by providing devices that allow the benefits of specific reflexology treatment by applying pressure on specifically chosen, targeted areas of the foot. The devices contain pockets for inserts associated with the chosen target area, which can be later be removed. After removal the same or different inserts may then be inserted into other, specifically chosen pockets for achieving different reflexology treatments thus allowing versatility of the device to provide a number of different reflexology treatments using the same device. There is also provided methods of using such devices including the use of more than one insert to provide more than one specific reflexology treatment.

In one embodiment, disclosed and claimed herein is a device for treating specifically targeted physical and/or mental conditions comprising a shoe insert comprising an array of sections, each section capable of removably receiving at least one pad, wherein the pad creates a raised area above the insert when inserted into at least one section and wherein the pad is capable of applying pressure to specifically selected, targeted positions on the bottom of the wearer's foot when worn.

In a second embodiment, disclosed and claimed herein is the above device wherein the raised area is between about 0.5 cm and about 5.0 cm above the insert and has a durometer rating between about 20 to about 75.

In a third embodiment are the above devices wherein the sections are at least one of pockets, depressions, slots, or guides.

In a fourth embodiment are the above devices wherein the pads have a regular or irregular shape.

In a fifth embodiment are the above devices wherein the sections are positioned in the array to coincide with areas on the bottom of the foot that relate to specifically selected reflexology points.

In a sixth embodiment are the above devices wherein the pads are removable and replaceable.

In a seventh embodiment is a device for treating specifically targeted physical and/or mental conditions comprising a foot covering device which covers at least a portion of an area of the sole of the foot and further comprises an array of sections, each section capable of removably receiving at least one insert, wherein the insert creates a thickened area in the foot covering when inserted into at least one section and wherein the insert is capable of applying pressure to specifically selected, targeted positions of the bottom of the wearer's foot when worn.

In an eighth embodiment is the above device wherein the thickened area adds between about 0.5 cm and about 5.0 cm to the foot covering thickness and has a durometer rating between about 20 to about 75.

In a ninth embodiment are the above devices wherein the sections are at least one of pockets, depressions, slots, or guides.

In a tenth embodiment are the above devices wherein the inserts have a regular or irregular shape.

In an eleventh embodiment are the above devices wherein the inserts are positioned in the array to coincide with areas of the foot that relate to specifically selected reflexology points.

In a twelfth embodiment are the above devices wherein the inserts are removable.

### BRIEF DESCRIPTION OF THE FIGURES

FIG. 1 illustrates an insert 11 into a shoe 10, the insert containing a pad 13 that is strategically placed in a position associated with a desired acupressure point of the wearer's foot.

FIG. 2 illustrates a sock 20 into which a pad 21 has been strategically placed in a position associated with a desired acupressure point of the wearer's foot, the pad adding a noticeable thickness to the thickness of the sock.

FIG. 3 illustrates a band 31 which has been placed onto a foot 30 with a pad 33 inserted into slot 32, the band placed in a strategically chosen position on the foot.

FIG. 4 shows a foot 40 and points 41 on the foot where reflexology theory indicates when pressure is applied to these points, headache relief results.

FIG. 5 shows a foot 50 with various positions indicated on the foot where reflexology theory indicates when pressure is applied, relief to the designated organs results.

### DETAILED DESCRIPTION OF THE DISCLOSURE

As used herein the term sections refers to areas into or onto which pads can be applied and held in place.

As used herein the term insert refers to a device which can placed into or onto a foot covering that fully or partially covers the foot, and which is not limited to size.

As used herein the term array refers to an undesignated number aligned in an undesignated pattern and is not meant to be limited to any number or pattern.

The principles of reflexology have shown that applying pressure to various positions on the foot, and hands, can help to treat various conditions affecting various organs and muscles in the body. Such organs include for example, headaches, tension, muscular discomfort, gastric distress, sexual function both positive and negative, neck tension, sinus issues, eye issues, shoulder pain and the like. As a further example, migraine headache pain can be alleviated through the use of acupressure to specific areas of the foot.

The present disclosure discloses and claims devices that are useful in treating a variety of physical and/or mental conditions using the principles of reflexology. The disclosed devices allow for the application of pressure to strategically selected areas of the foot. One such device is an insert for inserting into a shoe or other foot covering, such as, for example, an insole, which contain a variety of sections, such as, for example, pockets, arranged in an array at various positions in or on the insert which are associated with various pressure points on the foot in accordance with reflexology principles. In operation the user places a pad into the pocket of the insert, places the insert into a shoe and puts the shoe on. While walking the insert exerts pressure onto the desired pressure point of the foot. The user chooses which pressure point, or points, is desired for the particular treatment the user desires, and accordingly inserts a pad, or pads, into the pocket associated with that pressure point.

The device of the current disclosure allow the user to remove the pad from the insert as desired and continue walking, with the now pad-less insert remaining in the shoe without any pressure being applied. In this manner the user may periodically add one or more pads for pressure and remove them for periods of non-pressure, as desired.

As described the user can insert more than one pad into more than one pocket as desired. The insert of the current disclosure may completely fill the shoe from toe to heel, or it may partially fill the shoe, for example, it may only cover the toe to ball portion of the foot, or it may cover just the heel section of the shoe. This allows the user to have complete versatility in treatment options.

The insert may contain sections which are pockets into which a pad of desired dimension can be inserted. The section may also be a depression in the inset into which a pad of desired dimension can be fitted. Other types of structures can be included in or on the insert for allowing pads or desired dimension to be affixed, such as adhesive portions, Velcro®, slots, guides and the like.

The insert may also be inserted into other foot coverings such as shoes, as previously described, slippers, boots, socks, moccasins, slip-ons, sandals, athletic shoes, such as sneakers, golf shoes, football/soccer cleats, sprinting spikes, running shoes, ski boots, show shoes and the like.

The pads of the current disclosure are not limited in dimension, shape, thickness, or structure. For example, the pads may be circular, oval, square, rectangular, triangular, or irregular in shape. The pads may also vary in thickness. The thickness may depend on the amount of force of the pressure is desired, for example more pressure will be applied to the pressure point when to pad is thicker than a thinner pad which will exert less pressure. The current disclosure provides for the pad to be between about 0.5 centimeters (cm) and 5.0 cm above the insert. Or in the case of a sock-type device, from about 0.5 cm and about 5.0 cm thicker than the sock-type device thickness.

The pad of the current disclosure may be crowned in that the center of the pad may be thicker than the sides thus concentrating the thickness in the middle which concentrates the pressure to specific area of the foot, while applying integrally decreasing pressure away from the pressure point. The pad may have more than one crown throughout the pad. Such pads may be conical, cylindrical, semi-spherical, or combinations thereof.

The pad may be made of a variety of materials ranging from foam materials, plastic, polymers, rubber of various hardnesses or metal or combinations thereof. The pads of the current disclosure have a durometer of between about 20 (similar to a bicycle gel seat) and about 75 (similar to a tire tread).

Devices of the current disclosure include foot covering which include, for example, socks, stockings, bands, footies, bandages or slip-on type foot coverings. In the case of these foot coverings. When describing the insert or sock device with the pads inserted, the pad protrudes from the surface of the insert which is in proximity to the foot surface and therefore applies pressure to the surface of the foot when worn. As well the insert in the foot covering, such as a sock, it provides a thicker area in the covering which, when worn as in walking, the covering flattens out but the pad protrudes above the covering interface with the surface being walked on and provides a pressure on the foot surface. As in the case of the insert, the foot covering can contain an array of sections which are associated with specific areas of the foot so that when pads are inserted and the covering is worn by a user the pads apply pressure to a pressure point on the foot for a desired treatment. The foot covering has the attributes of the insert as described above including the described pads and sections.

A foot covering, as used in the context of this disclosure, can range from a convention sock which covers the complete foot and rise above the ankle to the knee, to a band or bandage, a slip-on, a slipper, a moccasin, stocking or the like, as is well known in the art. The foot covering may simply form fit to the foot as a sock are capable of doing, or in the case of bands or bandages may be applied to the foot by way of Velcro® attachments, pins, snaps, hooks, buttons, adhesive strips or other forms of attachment well known in the industry.

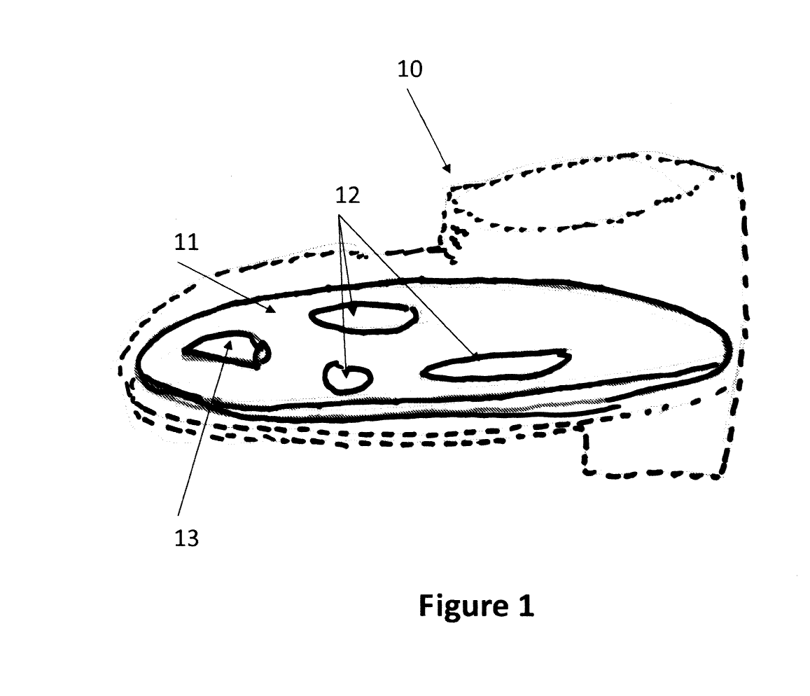

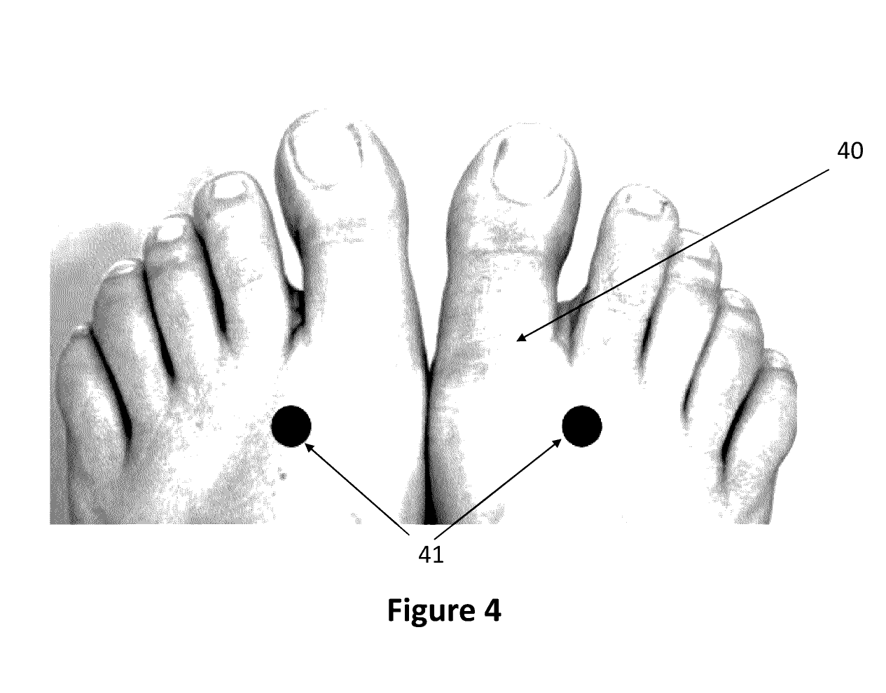

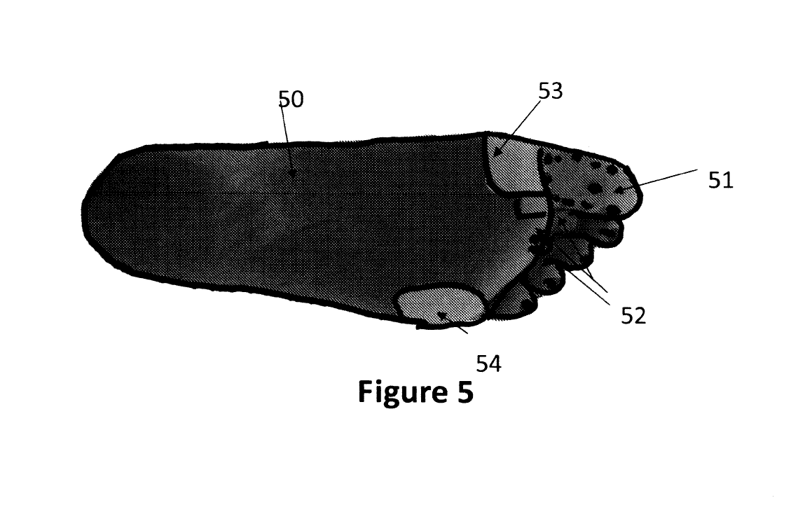

Turning now to the figures, FIG. 1 illustrates an insert 11 which is placed into a shoe 10. The insert 11 contains a number of pockets 12 which are capable of holding pads 13 that are strategically placed in a position associated with a desired acupressure point of the wearer's foot, see FIGS. 4 and 5. The pad 13 provides for a raised area in the insert which can apply pressure to the, in this case, ball area of the user's foot when it is worn and the user walks

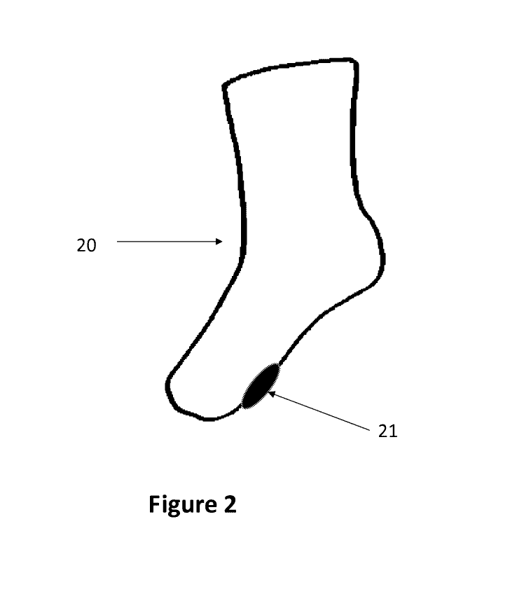

FIG. 2 illustrates a foot covering device 20, in this case a sock, into which a pad 21 has been inserted into a pocket (not shown). Again the pad provides for a thicker area in the sock. When the user slips the sock on the pad lines up with the desired portion of the foot to put pressure on the desired portion of the foot when the users walks.

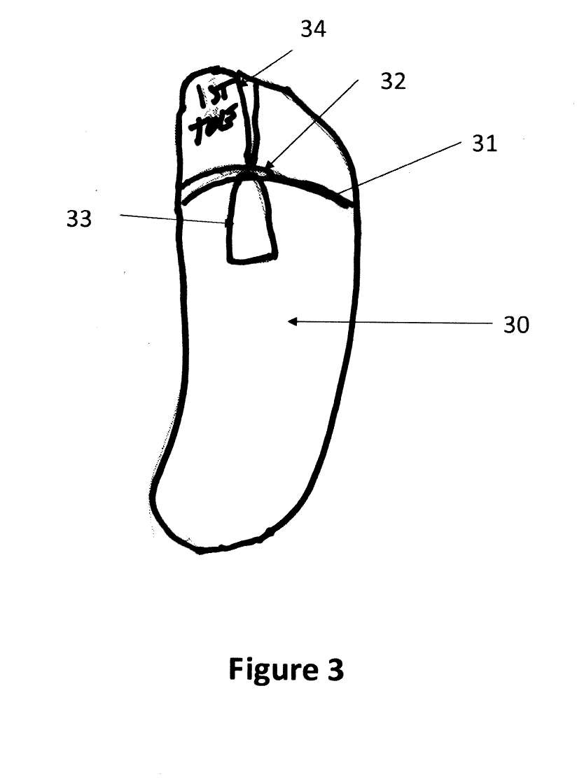

FIG. 3 illustrates a band or bandage type of foot covering 31 which is placed on the foot 30 in a strategy position. The band has a slot 32 into which a pad 33 has been placed. In this case the band is stretchable so as to stay positioned on the foot during the walking stage. Alternatively a stabilizing strap 34 is add to the device to help stabilize the position of the pad, in this case, over the toe.

FIG. 4 shows one of the principles of reflexology relating to migraine headaches. Pressure to the foot 40 areas 41 help to alleviate migraine headaches. The pressure is to be applied to the underside of the foot.

FIG. 5 also shows other pressure points utilizing the principles of reflexology. Note that areas 51 and 52 are associated with head and headaches, respectively.

### EXAMPLE

100 patients suffering from severe migraine headaches were given the device shown in FIG. 3. The device included pads inserted into pockets that were attached to an elastic bandage. The pads had a square shape with dimensions of 2.5 cm by 2.5 cm. the thick was 2 cm thick. When worn for 1 week, fully 75 patients reported some or all relief of symptoms of migraine headaches.

We claim:

1) A device for treating specifically targeted physical and/or mental conditions comprising a shoe insert comprising an array of sections, each section capable of removably receiving at least one pad, wherein the pad creates a raised area above the insert when inserted into at least one section and wherein the pad is capable of applying pressure to specifically selected, targeted positions on the bottom of the wearer's foot when worn.

2) The device of claim 1, wherein the raised area is between about 0.5 cm and about 5.0 cm above the insert.

3) The device of claim 1, wherein the sections comprise are at least one of pockets, depressions, slots, or guides.

4) The device of claim 1, wherein the pad has a durometer rating between about 20 to about 75.

5) The device of claim 1, wherein the pad have a regular or irregular shape.

6) The device of claim 1, wherein the sections are positioned to coincide with areas on the bottom of the foot that relate to specifically selected reflexology points.

7) The device of claim 1, wherein the pad is removable and replaceable.

8) A device for treating specifically targeted physical and/or mental conditions comprising a foot covering device which covers at least a portion of an area of the sole of the foot and further comprises an array of sections in the portion that covers the sole of the foot, each section capable of removably receiving at least one insert, wherein the insert creates a thickened area in the foot covering when inserted into at least one section and wherein the insert is capable of applying pressure to specifically selected, targeted positions of the bottom of the wearer's foot when worn.

9) The device of claim 8, wherein the foot covering device is a sock, a stocking, band, footie, bandage or a slip on object.

10) The device of claim 8, wherein the thickened area adds between about 0.5 cm and about 5.0 cm to the foot covering thickness.

11) The device of claim 8, wherein the sections are at least one of pockets, depressions, slots, or guides.

12) The device of claim 8, wherein the inserts have a durometer rating between about 20 to about 75.

13) The device of claim 8, wherein the inserts have a regular or irregular shape.

14) The device of claim 8, wherein the inserts are positioned to coincide with areas of the foot that relate to specifically selected reflexology points.

15) The device of claim 8, wherein the inserts are removable.
